(19) United States
(12) Patent Application Publication
(10) Pub. No.: US 2018/0352153 A1
(43) Pub. Date: Dec. 6, 2018

(54) IMAGE PROCESSING APPARATUS THAT GENERATES EVALUATION VALUE FOR EVALUATING LUMINANCE OF IMAGE DATA, IMAGE CAPTURING APPARATUS, METHOD FOR PROCESSING IMAGE, AND PROGRAM

(71) Applicant: CANON KABUSHIKI KAISHA, Tokyo (JP)

(72) Inventor: Nobuto Matsuda, Tokyo (JP)

(21) Appl. No.: 15/974,003

(22) Filed: May 8, 2018

(30) Foreign Application Priority Data
May 30, 2017 (JP) 2017-107072

(51) Int. Cl. H04N 5/232; H04N 5/235

(52) U.S. Cl. CPC H04N 5/23229; H04N 5/2353; H04N 5/2351

(57) ABSTRACT

An apparatus includes a band limiting circuit, a reducing circuit, a correcting circuit, and an evaluation-value generating circuit. The band limiting circuit is configured to perform a band limiting process on image data. The reducing circuit is configured to reduce the image data to generate reduced image data. The correcting circuit is configured to perform a correcting process corresponding to the attenuation rate of the band limiting process on a signal level obtained from the reduced image data. The evaluation-value generating circuit is configured to generate an evaluation value indicating the luminance of the image data based on the image data.

### BACKGROUND OF THE INVENTION

### Field of the Invention

The present disclosure relates to a method for generating an evaluation value for evaluating the luminance of image data.

### Description of the Related Art

In order to control exposure in an image capturing apparatus, the luminance of image data acquired by image capturing is to be evaluated. Known examples of a signal for use in the evaluation include an evaluation value generated from a luminance value obtained from image data and an evaluation value generated from the maximum value of an R-signal, a G-signal, and a B-signal in image data. There is a known method for detecting the peak of such an evaluation value and controlling the exposure so that no saturated region occurs in the image data on the basis of the luminance of the object corresponding to the peak.

However, when the amount of signals to be processed increases due to an increase in the number of pixels or the frame rate of the image data, the size of an image processing circuit for calculating the value for evaluating the luminance or power consumption may be disadvantageously increased.

For example, Japanese Patent Laid-Open No. 2015-061137 discloses a method for performing a reduction process on image data to generate reduced image data and generating an evaluation value from the reduced image data.

When image data is subjected to the reduction process, folding due to a high frequency component occurs. For that reason, the reduction process on image data is generally performed after performing band limitation for attenuating the signal levels of frequency components in the vicinity of a Nyquist frequency or higher than that using a low-pass filter or the like.

However, when the band limitation is performed to prevent folding, the signal levels of frequency components in the vicinity of the Nyquist frequency are lowered, so that the luminance component of an object having a high frequency component, such as a point light source, will be attenuated. Accordingly, when an object having a high frequency component, such as a point light source, has a high luminance level that affects exposure control of image data, high-accuracy exposure control may not be performed.

### SUMMARY OF THE INVENTION

In an aspect of the embodiments, an apparatus performs a band limiting process on image data, reduces the image data to generate reduced image data, performs a correcting process corresponding to the attenuation rate of the band limiting process on a signal level obtained from the reduced image data, and generates an evaluation value indicating the luminance of the image data based on the image data.

In another aspect of the embodiments, an apparatus performs a band limiting process on image data, performs a reduction process on the image data to generate reduced image data, determines whether each area in the reduced image data satisfies a predetermined condition, and for an area that is determined to satisfy the predetermined condition, generates an evaluation value indicating luminance of the image data based on a signal level of the reduced image data, and for an area that is not determined to satisfy the predetermined condition, generates an evaluation value indicating the luminance of the image data based on the signal level of image data before being subjected to the band limiting process and the reduction process.

Further features of the present disclosure will become apparent from the following description of exemplary embodiments with reference to the attached drawings.

### BRIEF DESCRIPTION OF THE DRAWINGS

FIG. 1 is a block diagram illustrating a configuration example of an image processing apparatus according to a first embodiment of the present disclosure.

FIG. 2A is a histogram of image data before being subjected to a band limiting process.

FIG. 2B is a histogram when the image data is subjected to a reduction process without being subjected to the band limiting process.

FIG. 2C is a histogram when the image data is subjected to the band limiting process.

FIG. 2D is a histogram when the image data is subjected to the band limiting process and is then subjected to the reduction process.

FIG. 3 is a flowchart for illustrating a process for generating an evaluation value from image data in the first embodiment.

FIG. 4 is a block diagram illustrating a configuration example of an image processing apparatus according to a second embodiment.

FIG. 5 is a flowchart for illustrating a process for generating an evaluation value from image data in the second embodiment.

FIG. 6 is a block diagram illustrating a configuration example of an image processing apparatus according to a third embodiment.

FIG. 7 is a flowchart for illustrating a process for generating an evaluation value from image data in the third embodiment.

### DESCRIPTION OF THE EMBODIMENTS

Embodiments of the present disclosure will be described hereinbelow with reference to the attached drawings.

### First Embodiment

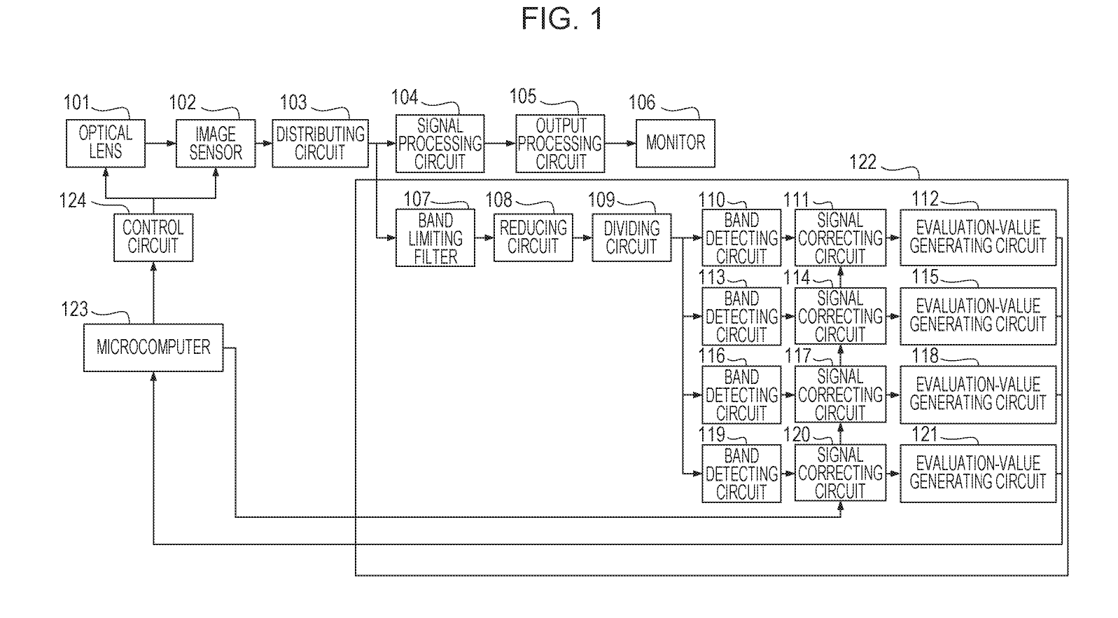

FIG. 1 is a block diagram illustrating a configuration example of an image processing apparatus according to a first embodiment of the present disclosure. In the present embodiment, a digital camera will be described as an example of the image processing apparatus. However, this is given for mere illustration, and the image processing apparatus is not limited to the digital camera. The image processing apparatus may be any other apparatuses capable of generating an evaluation value for use in exposure from image data. The present discloser may be implemented as any information processing apparatuses or image capturing apparatuses, such as digital video cameras, personal computers, mobile phones, smartphones, personal digital assistants (PDAs), tablet terminals, or portable media players. In the image processing apparatus illustrated in FIG. 1, each block except certain physical devices, such as an optical lens 101, an image sensor 102, and a monitor 106, may be configured as hardware using a dedicated logic circuit and a memory. Alternatively, each block may be configured as software by executing processing programs stored in a memory with a computer, such as a CPU.

In FIG. 1, the optical lens 101 has a focusing mechanism for focusing, a diaphragm mechanism for adjusting light quantity and the depth of field, a neutral density (ND) filter mechanism for adjusting light quantity, and a zoom mechanism for changing the focal length. However, some optical lenses do not have some of the above mechanisms. In the present embodiment, the optical lens 101 may be any optical lens that has the function of forming an image on the image sensor 102. The image sensor 102 is a charge-coupled device (CCD) image sensor or a complementary metal-oxide semiconductor (CMOS) image sensor, which converts incident light from the optical lens 101 to an electrical signal and outputs the electrical signal.

A distributing circuit 103 copies image data converted to the electrical signal by the image sensor 102 and distributes the two image data to a signal processing circuit 104 and an evaluation circuit 122. The signal processing circuit 104 includes circuits for performing a noise suppression process, a gamma correction process, an edge emphasizing process, a color correction process, and the like on the image data. The image data output from the signal processing circuit 104 is processed to output image data by an output processing circuit 105. The monitor 106 displays a moving image using the image data received from the output processing circuit 105. Although FIG. 1 illustrates only the monitor 106, the image data output from the output processing circuit 105 is input also to a recording medium for recording the image data and an output interface that outputs the image data to an external information processing apparatus.

The evaluation circuit 122 includes a band limiting filter 107, a reducing circuit 108, a dividing circuit 109, a first band detecting circuit 110, a first signal correcting circuit 111, and a first evaluation-value generating circuit 112. The evaluation circuit 122 further includes a second band detecting circuit 113, a second signal correcting circuit 114, a second evaluation-value generating circuit 115, a third band detecting circuit 116, a third signal correcting circuit 117, a third evaluation-value generating circuit 118, a fourth band detecting circuit 119, a fourth signal correcting circuit 120, and a fourth evaluation-value generating circuit 121.

The image data output from the distributing circuit 103 is input to the band limiting filter 107. The band limiting filter 107 performs a band limiting process on the image data for preventing frequency components higher than a Nyquist frequency determined by the sampling interval in the subsequent reduction process from folding due to the reduction process.

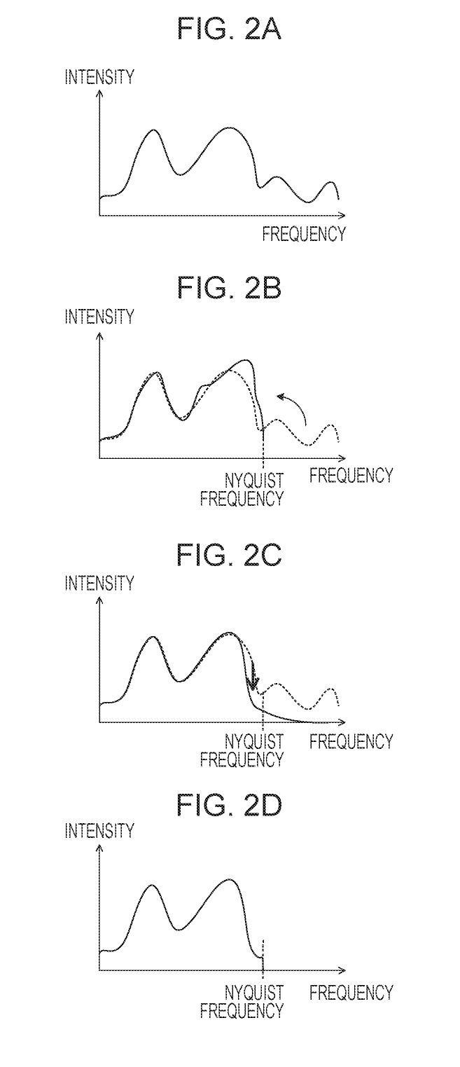

FIGS. 2A to 2D are diagrams for illustrating folding due to the reduction process. FIG. 2A illustrates a histogram of image data before being subjected to the band limiting process. In this histogram, the horizontal axis indicates frequency components, which become higher to the right. The vertical axis indicates the intensities of the signals of the frequency components, which depend on the object. FIG. 2B illustrates a histogram when the image data is subjected to the reduction process without being subjected to the band limiting process. The frequency components higher than the Nyquist frequency fold to lower frequencies than the Nyquist frequency, so that the intensities of the frequency components in the vicinity of the Nyquist frequency have changed. In contrast, FIG. 2C illustrates a histogram when the image data before being subjected to the reduction process is subjected to the band limiting process. The intensities of the frequency components higher than the Nyquist frequency are suppressed into almost zero, and the intensities of frequency components lower than but near the Nyquist frequency are also suppressed. FIG. 2D illustrates a histogram when the image data is subjected to the band limiting process and is then subjected to the reduction process. The intensities of the frequency components higher than the Nyquist frequency become almost zero, and the intensities of frequency components lower than the Nyquist frequency is substantially the same as those of FIG. 2C.

The image data subjected to the band limiting process by the band limiting filter 107 is then subjected to the reduction process by the reducing circuit 108, so that image data having fewer pixels is generated. The evaluation circuit 122 generates an evaluation value for use in exposure control from the reduced image data. The image data output from the band limiting filter 107 is input to the dividing circuit 109. The dividing circuit 109 divides the input image data into four areas and inputs the four divided image data of quarter size to the first to fourth band detecting circuits 110, 113, 116, and 119. The first signal correcting circuit 111 performs a correcting process according to the attenuation characteristic of the band limiting filter 107 on the image data output from the first band detecting circuit 110. The first evaluation-value generating circuit 112 generates an evaluation value for use in exposure control from the corrected image data. This also applies to the second to fourth signal correcting circuits 114, 117, and 120 and the second to fourth evaluation-value generating circuits 115, 118, and 121. Thus, the image data is divided into four areas, and an evaluation value for use in exposure control can be generated in each of the divided four image areas.

A microcomputer 123 calculates a control quantity for exposure control on the basis of the evaluation values obtained from the divided four image data and outputs the control quantity to a control circuit 124. The control circuit 124 controls the diaphragm and the ND filter of the optical lens 101 on the basis of the control quantity. The control circuit 124 also controls the electronic shutter and the gain of the image sensor 102.

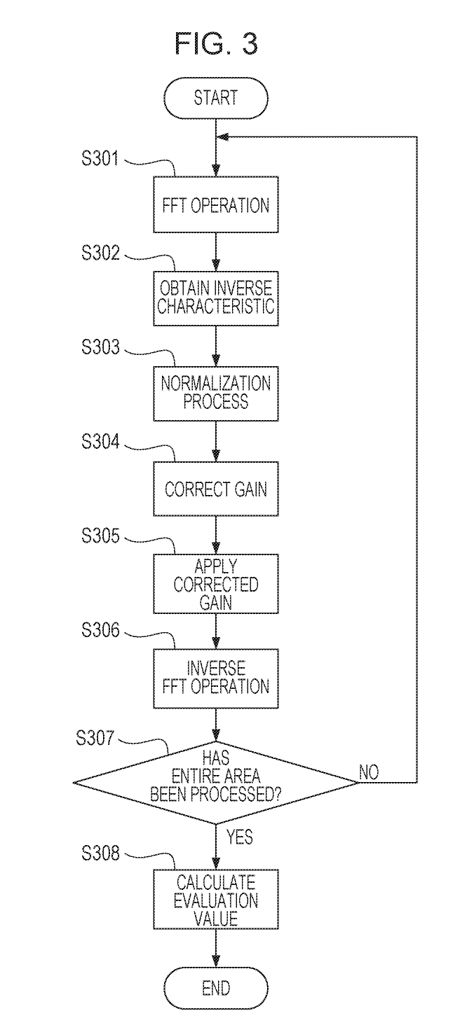

Next, the process in the first band detecting circuit 110, the first signal correcting circuit 111, and the first evaluation-value generating circuit will be described with reference to FIG. 3. The same process is performed also in the second to fourth band detecting circuits 113, 116, and 119, the second to fourth signal correcting circuits 114, 117, and 120, and second to fourth evaluation-value generating circuits 115, 118, and 121.

FIG. 3 is a flowchart for illustrating the process for generating an evaluation value from image data in the first embodiment. In step S301, the band detecting circuit 110 selects image data in a predetermined range including target pixels from the input image data and separates the image data into frequency components using fast Fourier transform (FFT) to obtain a spectrum which is the intensity distribution of signals of the frequencies.

In step S302, the band detecting circuit 110 obtains the inverse characteristic of the attenuation characteristic of the band limiting filter 107. Since the characteristic of the band limiting filter 107 is known, the inverse characteristic may be stored in advance in a memory (not shown).

In step S303, the band detecting circuit 110 performs a normalizing process so that the minimum value of the obtained inverse characteristic takes 1 and uses it as the original data of a correction gain.

If the correction gain is too large, the ratio of a noise component in the signal to which the correction gain is used can be increased. For that reason, in step S304, the band detecting circuit 110 clips gains larger than a predetermined gain value A to obtain a final correction gain.

In step S305, the signal correcting circuit 111 multiplies the spectrum obtained in step S301 by the correction gain obtained in step S304 to generate a corrected spectrum.

In step S306, the evaluation-value generating circuit 112 performs inverse Fourier transform on the corrected spectrum calculated in step S305 to obtain the signal level of the image data in the predetermined range including target pixels.

The first band detecting circuit 110, the first signal correcting circuit 111, and the first evaluation-value generating circuit 112 repeat the process from step S301 to S306 on the entire area of the image data input to the band detecting circuit 110 (step S307).

In step S308, the evaluation-value generating circuit 112 generates an evaluation value by calculating the signal level obtained in step S306 by a predetermined method, and the flowchart ends. The predetermined method here includes various calculation methods according to the purpose of exposure control. Since the signal level corresponds to the luminance value, a method of obtaining the peak of the signal level and calculating the difference between the peak and a predetermined level may be used. Another conceivable method is obtaining the mean value of the amplitude levels of the entire area of image data input to the band detecting circuit 110 and calculating the difference between the mean value and a predetermined value. The microcomputer 123 can set the luminance of image data to a desired range by calculating a control quantity for exposure control on the basis of the evaluation value.

In the present embodiment, first, the reduced image data is converted to frequency components, as described above. A correction gain for compensating the attenuation of the signal level due to the band limiting process is applied to the frequency components to recover the frequency components to amplitude levels near the levels before the reduction process is performed. With this configuration, the accuracy of exposure control can be increased even when an evaluation value is calculated from reduced image data. In the present embodiment, the image data is divided into four areas, and an evaluation value for use in exposure control is obtained for each divided image area. It is not always necessary to divide the image data, and one band detecting circuit, one signal correcting circuit, and one evaluation-value generating circuit may be provided.

### Second Embodiment

Next, a second embodiment of the present disclosure will be described. In the first embodiment, the Fourier transform is performed to correct the frequency characteristic in order to obtain the intensity distribution for the frequencies. In the present embodiment, the Fourier transform is not performed.

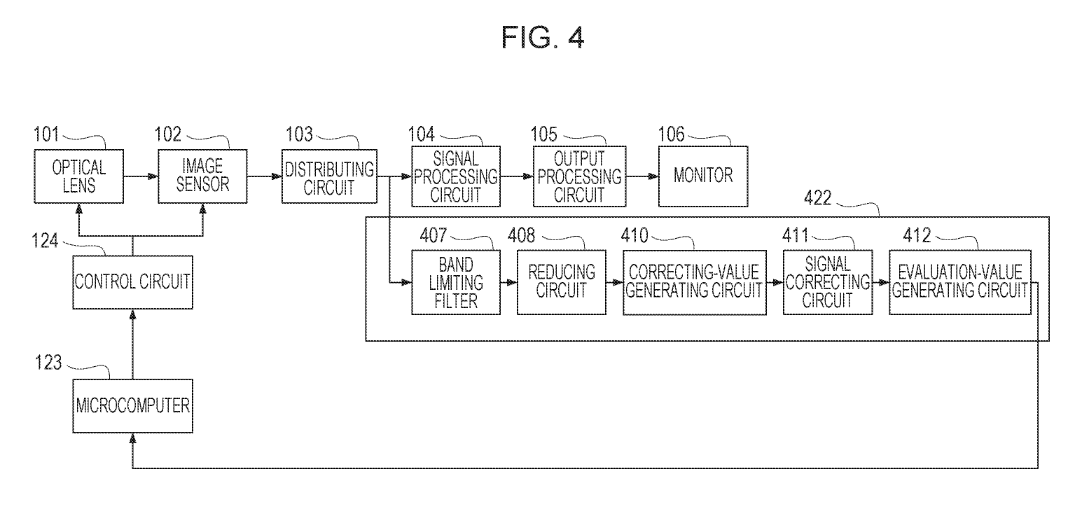

FIG. 4 is a block diagram illustrating a configuration example of the image processing apparatus according to the second embodiment. The optical lens 101 to the monitor 106, the microcomputer 123, and the control circuit 124 are the same as those of the first embodiment. An evaluation circuit 422 differs from the evaluation circuit 122 of the first embodiment.

In the evaluation circuit 422, a band limiting filter 407 is used to perform a band limiting process on image data. The image data subjected to the band limiting process by the band limiting filter 407 is then subjected to a reduction process by a reducing circuit 408 into image data with fewer pixels. The band limiting filter 407 and the reducing circuit 408 respectively perform the same processes as those of the band limiting filter 107 and the reducing circuit 108 in FIG. 1. A correction-value generating circuit 410 estimates the frequency components of a high-luminance object to determine a correction value. A signal correcting circuit 411 corrects the signal level of the image data subjected to the reduction process using the correction value determined by the correction-value generating circuit 410. An evaluation-value generating circuit 412 generates an evaluation value for use in exposure control from the data subjected to the correcting process.

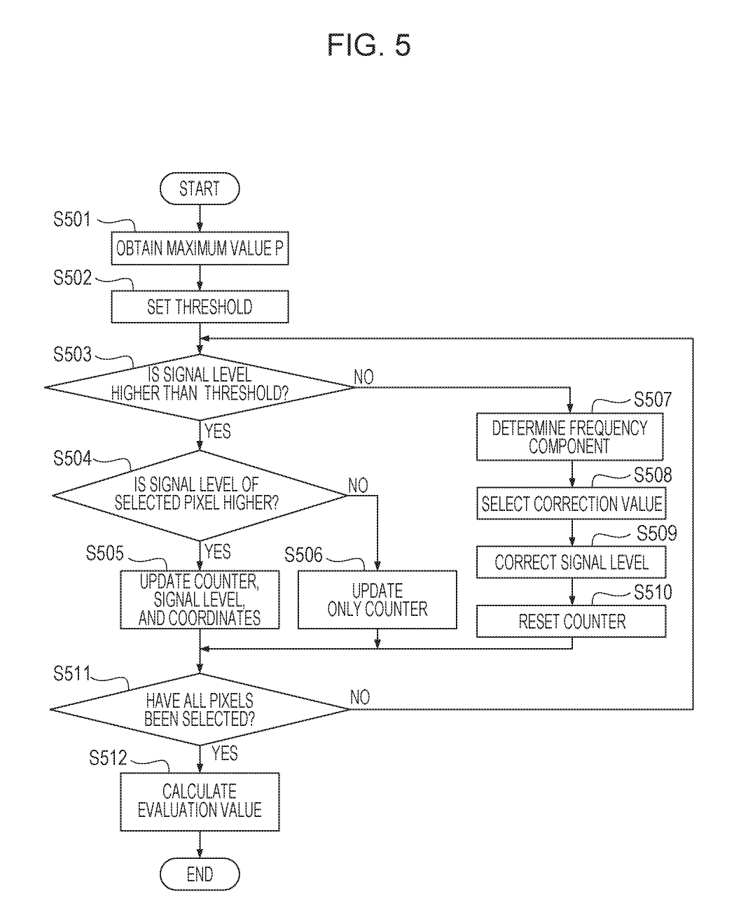

Next, the process performed by the correction-value generating circuit 410, the signal correcting circuit 411, and the evaluation-value generating circuit 412 will be described with reference to FIG. 5.

FIG. 5 is a flowchart for illustrating the process for generating an evaluation value from image data in the second embodiment. In step S501, the correction-value generating circuit 410 detects the maximum value P of the signal levels of all the pixels of the image data. Alternatively, the correction-value generating circuit 410 may detect the maximum value P of the signal levels of all the pixels of image data of the previous frame.

In step S502, the correction-value generating circuit 410 sets a value obtained by multiplying the maximum value P by a predetermined percentage a as a threshold. This threshold is a value for use in detecting an object having a luminance similar to the maximum value P; for example, 0.95 is set as the value of the percentage α. The count value of the pixels (described later) is set to 0.

In step S503, the correction-value generating circuit 410 selects pixels in sequence from a pixel at the upper left coordinates of the image data and compares the signal level of the selected pixel and the threshold determined in step S502. If the comparison shows that the signal level is higher than the threshold, the process goes to step S504.

In step S504, the correction-value generating circuit 410 compares the signal level of the selected pixel and the signal level stored in the memory. If the signal level of the selected pixel is higher, the process goes to step S505. This memory stores the signal level of a pixel equal to or higher than the threshold and highest of pixels selected before and its coordinates (position). If the signal level and the coordinates of the pixel are not stored in the memory, the process goes to step S505.

In step S505, the correction-value generating circuit 410 adds 1 to the count of the pixels to update the information stored in the memory using the coordinates and the signal level of the selected pixel, and the process goes to step S511.

In step S506, the correction-value generating circuit 410 adds 1 to the count of the pixels, but does not update the information stored in the memory, and the process goes to step S511.

In step S511, the correction-value generating circuit 410 determines whether all the pixels have been selected in step S503. If all the pixels have been selected, the process goes to step S512, and if an unselected pixel remains, the process returns to step S503.

If, in step S503, the signal level of the selected pixel is equal to or lower than the threshold, the process goes to step S507.

In step S507, the correction-value generating circuit 410 regards the count value of the pixels as the size of the high-luminance object counted up to the latest and determines a frequency component corresponding to the size. If the count is zero, the correction-value generating circuit 410 omits steps S507 to S510 and goes to step S511.

In step S508, the correction-value generating circuit 410 selects a correction value corresponding to the selected frequency component from prepared correction values.

In step S509, the signal correcting circuit 411 corrects the signal level last updated in step S505 using the correction value selected in step S508 and stores the signal level as a candidate of the peak value in the memory.

In step S510, the correction-value generating circuit 410 sets the count value of the pixels to 0 and clears the coordinates and the signal level of the pixel updated in step S509, and the process goes to step S511.

If the signal levels of the pixels selected by the correction-value generating circuit 410 continuously exceed the threshold, the process of step S504, S505 (or S506), S511, and S503 is repeated. At that time, the count value of the pixels increases, and the coordinates and the signal level of a pixel having the highest signal level among the pixels are stored in the memory. Thereafter, when the signal level of the pixel selected by the correction-value generating circuit 410 becomes equal to or lower than the threshold, the size (width) of the high-luminance object can be estimated from the count value at that time. Therefore, a dominant frequency component of this high-luminance object is determined on the basis of the size. The value of the dominant frequency component for this size is to be obtained from experience or experimentally and is to be prepared in the memory. Since the degree of attenuation of the signal level due to the band limiting process performed by the band limiting filter 407 is known, a gain for compensating the attenuation can be determined if a dominant frequency component in the high-luminance object is found. By multiplying the highest signal level of the high-luminance object by the gain with the signal correcting circuit 411, the peak value of the signal level after the attenuation of the signal level due to the band limiting process is compensated can be obtained. The correction-value generating circuit 410 resets the count value of the pixels and so on and selects the next pixel. By executing such a process, the peak value of the signal level after the attenuation of the signal level due to the band limiting process is compensated can be obtained for each high-luminance object with a signal level higher than the threshold set in step S502.

In step S512, the evaluation-value generating circuit 412 selects the maximum value from the peak values stored in the memory in step S509, calculates an evaluation value from the maximum value, transmits the evaluation value to the microcomputer 123, and terminates the flowchart.

By controlling exposure on the basis of the evaluation value, the microcomputer 123 prevents saturation of the image data.

Thus, in the present embodiment, each frequency component can be recovered to a level close to the amplitude before the reduction process is performed without performing the Fourier transform and the inverse Fourier transform, as in the first embodiment. Also in the present embodiment, the image data may be divided into a plurality of areas for processing as in the first embodiment. However, if the image data is simply divided, the size of an object on the boundary cannot be detected. For that reason, the divided areas may have overlapping portions.

### Third Embodiment

Next, a third embodiment of the present disclosure will be described. In the present embodiment, the signal correcting circuits 111 and 411 in the first and second embodiments are not provided, but a clipping circuit for image data subjected to no reduction process is provided.

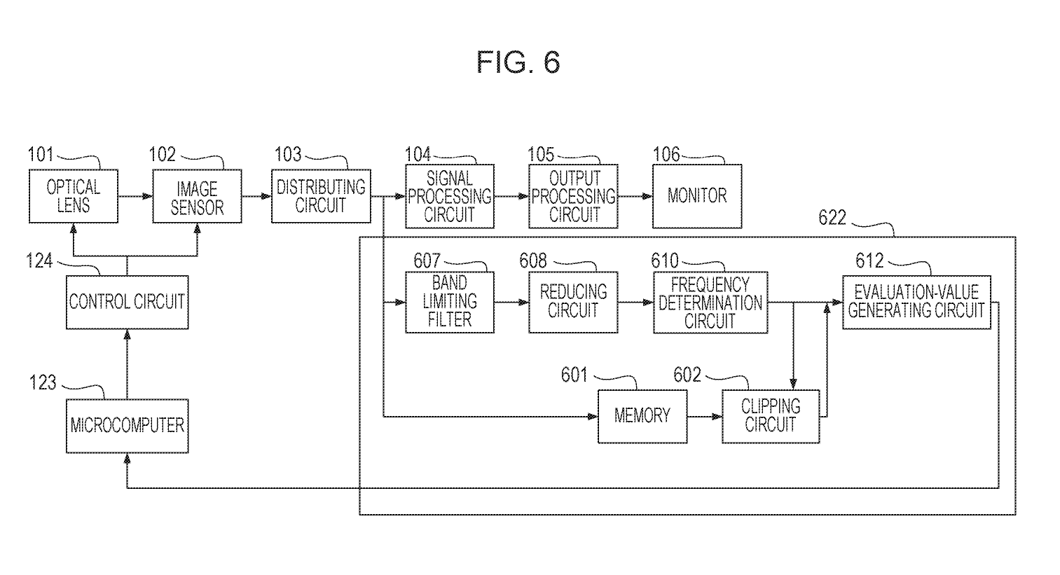

FIG. 6 is a block diagram illustrating a configuration example of an image processing apparatus according to a third embodiment. The optical lens 101 to the monitor 106, the microcomputer 123, and the control circuit 124 are the same as those of the first embodiment, and an evaluation circuit 622 differs from the evaluation circuit 122 of the first embodiment.

In the evaluation circuit 622, a band limiting filter 607 is used to perform a band limiting process on the image data. The image data subjected to the band limiting process by the band limiting filter 607 is then subjected to a reduction process by a reducing circuit 608 into image data with fewer pixels. The band limiting filter 607 and the reducing circuit 608 respectively perform the same processes as those of the band limiting filter 107 and the reducing circuit 108 in FIG. 1. A frequency determination circuit 610 determines a dominant frequency component in the high-luminance object on the basis of the count value of high-luminance pixels by the same method as the method of the correction-value generating circuit 410 in FIG. 4. A clipping circuit 602 clips a partial area from the image data before being subjected to the band limiting process and the reduction process, stored in a memory 601, on the basis of the determination on the frequency component and transmits a signal level corresponding to the target pixel to an evaluation-value generating circuit 612. The evaluation-value generating circuit 612 generates an evaluation value for use in exposure control on the basis of the signal level transmitted from the frequency determination circuit 610 or the clipping circuit 602.

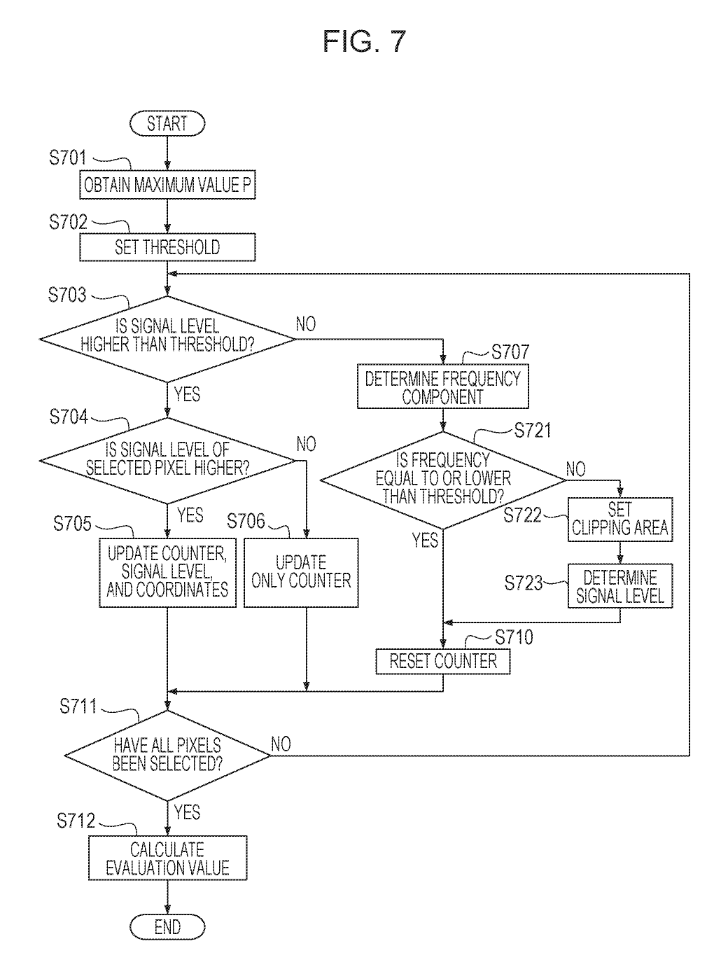

Next, the process performed in the memory 601, the clipping circuit 602, the frequency determination circuit 610, and the evaluation-value generating circuit 612 will be described with reference to FIG. 7. FIG. 7 is a flowchart for illustrating a process for generating an evaluation value from image data in the third embodiment. Since the process from step S701 to S707 and the process from step S710 to S712 in FIG. 7 are the same as the process from step S501 to S507 and the process from step S510 to S512 in FIG. 5, descriptions thereof will be omitted. In those steps, the process performed by the correction-value generating circuit 410 in FIG. 5 is performed by the frequency determination circuit 610 in FIG. 7.

In step S721, the frequency determination circuit 610 determines whether the dominant frequency component of the high-luminance object determined in step S707 satisfies the condition that the frequency is less than the threshold. As illustrated in FIG. 2C, the higher the frequency, the higher the attenuation rate of the signal level. The threshold is set to the highest frequency of frequencies with a low attenuation rate due to the band limiting process, so that the influence thereof may be negligible. In other words, if the frequency is higher than the threshold, the attenuation rate due to the band limiting process cannot be ignored. If the frequency determination circuit 610 determines that the frequency is equal to or lower than the threshold, the frequency determination circuit 610 transmits the signal level of the selected pixel of the reduced image data to the evaluation-value generating circuit 612, and the process goes to step S710. In contrast, if it is determined that the frequency is higher than the threshold, the process goes to step S722.

In step S722, the clipping circuit 602 clips a partial area corresponding to pixels for which the frequency determination circuit 610 determines that they have frequencies higher than the threshold from the image data stored in the memory 601. The memory 601 stores image data output from the distributing circuit 103, the image data being subjected to no band limiting process and no reduction process. By clipping a partial area corresponding pixels, for which the frequency determination circuit 610 determines that they have frequencies higher than the threshold from the image data stored in the memory 601, according to the reduction rate of the reducing circuit 608, a signal level that is not attenuated can be obtained. The clipping circuit 602 determines the highest signal level among the signal levels of the pixels in the clipped area. The clipping circuit 602 transmits the determined signal level as the signal level of the selected pixel in the reduced image data to the evaluation-value generating circuit 612, and the process goes to step S710. If the count is zero in step S707, then the frequency determination circuit 610 omits step S721, S722, S723, and S710, and the process goes to step S711.

As described above, in the present embodiment, for a pixel whose signal level is determined to have a high attenuation rate in the reduced image data, the signal level is determined from the original image data. Since not the entire original image data, but only pixels whose signal levels are determined to have a high attenuation rate in the reduced image data are referred to, the process load can be reduced.

Alternatively, after an area in which high-luminance pixels are continuous is extracted from an area including all the pixels, the process from step S707 to S723 may be performed on the extracted area.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2017-107072, filed May 30, 2017, which is hereby incorporated by reference herein in its entirety.

What is claimed is:

1. An apparatus comprising:
at least one memory device;
at least one processor;
a band limiting unit configured to perform a band limiting process on image data;
a reducing unit configured to reduce the image data to generate reduced image data;
a correcting unit configured to perform a correcting process corresponding to an attenuation rate of the band limiting process on a signal level obtained from the reduced image data; and
an evaluation-value generating unit configured to generate an evaluation value indicating luminance of the image data based on the image data,
wherein the band limiting unit, the reducing unit, the correcting unit, and the evaluation-value generating unit are implemented by the at least one processor executing at least one program stored in the at least one memory device.

2. The apparatus according to claim 1,
wherein the correcting unit separates the reduced image data into frequency components and corrects a signal level of each frequency component according to an attenuation rate corresponding to each frequency component.

3. The apparatus according to claim 2,
wherein the correcting unit applies a gain corresponding to each frequency component to the signal level of each frequency component and sets the gain so as not to exceed a predetermined value.

4. The apparatus according to claim 2,
wherein the correcting unit separates the reduced image data into frequency components by applying a Fourier transform on the reduced image data.

5. The apparatus according to claim 4,
wherein the correcting unit applies an inverse Fourier transform to the frequency component corrected according to the attenuation rate corresponding to each frequency component.

6. The apparatus according to claim 1,
wherein the correcting unit counts continuous pixels whose signal levels are higher than a threshold in the reduced image data and performs a correcting process according to the attenuation rate of the band limiting process based on the count.

7. The apparatus according to claim 6,
wherein the correcting unit determines a gain to be applied to the signal level of a pixel in the counted area based on the count.

8. An apparatus comprising:
at least one memory device;
at least one processor;
a band limiting unit configured to perform a band limiting process on image data;
a reducing unit configured to perform a reduction process on the image data to generate reduced image data;
a determination unit configured to determine whether each area in the reduced image data satisfies a predetermined condition; and
an evaluation-value generating unit configured to, for an area that is determined to satisfy the predetermined condition, generate an evaluation value indicating luminance of the image data based on a signal level of the reduced image data, and for an area that is not determined to satisfy the predetermined condition, generate an evaluation value indicating the luminance of the image data based on the signal level of image data before being subjected to the band limiting process and the reduction process,
wherein the band limiting unit, the reducing unit, the determination unit, and the evaluation-value generating unit are implemented by the at least one processor executing at least one program stored in the at least one memory device.

9. The apparatus according to claim 8,
wherein the determination unit counts continuous pixels whose signal levels are higher than a threshold in the reduced image data, determines whether a frequency in each area is equal to or lower than a threshold based on the count, and determines an area whose frequency is equal to or lower than the threshold as an area that satisfies the predetermined condition.

10. An apparatus comprising:
an image sensor;
at least one memory device;
at least one processor;
a control unit configured to control exposure of the image sensor;
a band limiting unit configured to perform a band limiting process on image data;
a reducing unit configured to reduce the image data to generate reduced image data;
a correcting unit configured to perform a correcting process corresponding to an attenuation rate of the band limiting process on a signal level obtained from the reduced image data; and
an evaluation-value generating unit configured to generate an evaluation value indicating luminance of the image data based on the image data,
wherein the control unit controls exposure of the image sensor based on the generated evaluation value, and
wherein the control unit, the band limiting unit, the reducing unit, the correcting unit, and the evaluation-value generating unit are implemented by the at least one processor executing at least one program stored in the at least one memory device.

11. An apparatus comprising:
an image sensor;
at least one memory device;
at least one processor;
a control unit configured to control exposure of the image sensor;
a band limiting unit configured to perform a band limiting process on image data;
a reducing unit configured to perform a reduction process on the image data to generate reduced image data;
a determination unit configured to determine whether each area in the reduced image data satisfies a predetermined condition; and
an evaluation-value generating unit configured to, for an area that is determined to satisfy the predetermined condition, generate an evaluation value indicating luminance of the image data based on a signal level of the reduced image data, and for an area that is not determined to satisfy the predetermined condition, generate an evaluation value indicating the luminance of the image data based on the signal level of image data before being subjected to the band limiting process and the reduction process,
wherein the control unit controls exposure of the image sensor based on the generated evaluation value, and
wherein the control unit, the band limiting unit, the reducing unit, the determination unit, and the evaluation-value generating unit are implemented by the at least one processor executing at least one program stored in the at least one memory device.

12. A method for processing an image, the method comprising:
performing a band limiting process on image data;
reducing the image data to generate reduced image data;
performing a correcting process corresponding to an attenuation rate of the band limiting process on a signal level obtained from the reduced image data; and
generating an evaluation value indicating luminance of the image data based on the image data.

13. The method according to claim 12, wherein the performing the correcting process includes separating the reduced image data into frequency components and correcting a signal level of each frequency component according to an attenuation rate corresponding to each frequency component.

14. The method according to claim 12, wherein the performing the correcting process includes counting continuous pixels whose signal levels are higher than a threshold in the reduced image data and performing a correcting process according to the attenuation rate of the band limiting process based on the count.

15. A method for processing an image, the method comprising:
performing a band limiting process on image data;
performing a reduction process on the image data to generate reduced image data;
determining whether each area in the reduced image data satisfies a predetermined condition; and
for an area that is determined to satisfy the predetermined condition, generating an evaluation value indicating luminance of the image data based on a signal level of the reduced image data, and for an area that is not determined to satisfy the predetermined condition, generating an evaluation value indicating the luminance of the image data based on the signal level of image data before being subjected to the band limiting process and the reduction process.

16. The method according to claim 15,
wherein the determining includes counting continuous pixels whose signal levels are higher than a threshold in the reduced image data, determining whether a frequency in each area is equal to or lower than a threshold based on the count, and determining an area whose frequency is equal to or lower than the threshold as an area that satisfies the predetermined condition.

17. A nonvolatile memory that stores a program for causing a computer of an apparatus to execute a control method, the control method comprising:
performing a band limiting process on image data;
reducing the image data to generate reduced image data;
performing a correcting process corresponding to an attenuation rate of the band limiting process on a signal level obtained from the reduced image data; and
generating an evaluation value indicating luminance of the image data based on the image data subjected to the correcting process.

18. The nonvolatile memory according to claim 17,
wherein the performing the correcting process includes separating the reduced image data into frequency components and correcting a signal level of each frequency component according to an attenuation rate corresponding to each frequency component.

19. The nonvolatile memory according to claim 17,
wherein the performing the correcting process includes counting continuous pixels whose signal levels are higher than a threshold in the reduced image data and performing a correcting process according to the attenuation rate of the band limiting process based on the count.

20. A nonvolatile memory that stores a program for causing a computer of an apparatus to execute a control method, the control method comprising the steps of:
performing a band limiting process on image data;
performing a reduction process on the image data to generate reduced image data;
determining whether each area in the reduced image data satisfies a predetermined condition; and
for an area that is determined to satisfy the predetermined condition, generating an evaluation value indicating luminance of the image data based on a signal level of the reduced image data, and for an area that is not determined to satisfy the predetermined condition, generating an evaluation value indicating the luminance of the image data based on the signal level of image data before being subjected to the band limiting process and the reduction process.
